(19) United States
(12) Patent Application Publication
(10) Pub. No.: US 2015/0381388 A1
(43) Pub. Date: Dec. 31, 2015

(54) CHANNEL ESTIMATION IN WIRELESS COMMUNICATIONS

(71) Applicant: NOKIA SOLUTIONS AND NETWORKS OY, Espoo (FI)

(72) Inventor: Wolfgang ZIRWAS, Munich (DE)

(73) Assignee: NOKIA SOLUTIONS AND NETWORKS OY, Espoo (FI)

(21) Appl. No.: 14/766,527

(22) PCT Filed: Feb. 8, 2013
(86) PCT No.: PCT/EP2013/052577

§ 371 Date: Aug. 7, 2015

(51) Int. Cl. H04L 25/02; H04W 56/00; H04L 5/00

(52) U.S. Cl. CPC H04L 25/0204; H04L 5/001; H04L 5/005; H04L 5/0035; H04W 56/001; H04L 5/0023

(57) ABSTRACT

Transmission of reference symbols for multiple carriers is coordinated to cause coherent transmission of the reference symbols for facilitating a channel estimation procedure for the multiple carriers on a bandwidth extending over the multiple carriers. At a receiving device the coordinated transmission of the reference symbols for multiple carriers is received on the extended bandwidth and a channel estimation procedure is provided based on the reference symbols received on the bandwidth extending over the multiple carriers.

This disclosure relates to channel estimation in wireless communications. A wireless communication system can be seen as a facility that enables communication sessions between two or more nodes such as fixed or mobile devices capable of wireless communications, access nodes such as base stations, relays, servers and so on. Examples of wireless systems include public land mobile networks (PLMN) such as cellular networks, satellite based communication systems and different wireless local networks, for example wireless local area networks (WLAN). A communication system and compatible communicating entities typically operate in accordance with a given standard or specification which sets out what the various entities associated with the system are permitted to do and how that should be achieved. For example, the standards, specifications and related protocols can define the manner how various entities shall communicate, how various aspects of the communications shall be implemented and how different entities involved in communications shall be configured. Various development stages of standards are often referred to as releases.

Wireless systems can be divided in coverage areas typically referred to as cells. A cell can be provided by a base station. A base station site may provide a plurality of cells. A user can access the communication system via the base station by means of an appropriate communication device. A communication device of a user is often referred to as user equipment (UE) or terminal. A communication device is provided with an appropriate signal receiving and transmitting arrangement for enabling communications with other nodes, typically a base station or another communication device. The communication device may access carriers provided by nodes such as base stations, other communications devices and so on, and transmit and/or receive communications on the carriers.

A node may communicate simultaneously on a multiple of carriers. An example of such arrangements is carrier aggregation (CA) where component carriers (CC) provide an aggregated carrier. Component carriers (CC) may be provided by a system of a single network operator or systems or a plurality of network operators.

Coordinated multipoint transmission (CoMP) is an example of a technique where combined results of reception by a plurality of stations from a source device or reception of signals transmitted from a plurality of sources can be utilised. CoMP can be provided for example in network scenarios where carrier aggregation is employed. In such arrangement a centralised processing unit controlling carrier aggregation may also be provided.

Channel state information (CSI) is an example of information that is used in wireless systems. CSI is typically used for defining properties of a communication channel to describe how a signal propagates from a transmitter to a receiver. CSI represents the combined effect of, for example, scattering, fading, and power decay with distance. CSI makes it possible to adapt transmissions to current channel conditions and can be advantageously utilised e.g. for achieving reliable communication with high data rates e.g. in multi-antenna systems. As precise as possible channel state information (CSI) is desired. This may be of particular importance for coordinated multipoint transmission and other systems where multiple channel components are involved, for example for multiple input multiple output (MIMO) based systems.

At least some parts of channel state information may need to be based on an estimate. This may be so e.g. because the channel conditions vary and so instantaneous CSI needs to be estimated on a short-term basis. A common approach is to use so-called training or pilot sequences or reference signals where known sequences or signals are transmitted and the CSI is estimated at the receiver based on these pilot signals. The estimation can be quantized and fed back to the transmitter. It is also possible that the receiver simply returns measurement results to the transmitter. Reverse-link estimation is also known.

A recent development is the so called interference mitigation framework, IMF-A. IMF-A is expected to—provide significant performance gains in suitable scenarios. These gains have been achieved either for ideal channel estimation and prediction or for very low user mobility. A powerful channel estimation, prediction and reporting technique would be of great interest to achieve these gains also for higher mobility and with high robustness.

Another example of operation where estimated information regarding a channel can be used is demodulation.

As accurate as possible channel estimation and prediction would be useful e.g. in applications for joint transmission such as CoMP, MIMO, beamforming or other techniques relying on accurate information regarding several radio channel components. A challenge for e.g. joint (JT) CoMP is that channel estimation is needed for many channel components with high accuracy. For example, in 3^{rd} Generation Partnership Project (3GPP) Long Term Evolution (LTE) based systems so called CSI reference symbols (CSI-RS) for channel sounding are sent per component carrier (CC) with a maximum bandwidth of 20 MHz. Due to frequency guard bands useful frequency band is limited to 1200 physical resource blocks (PRBs). As each PRB consist of 12 subcarriers with a 15 kHz subcarrier spacing this results in an overall bandwidth of about 18 MHz. Typically the receiving devices, such as user equipment, are doing CSI estimation per PRB with the drawback of a significant interpolation error at PRB band edges. Even an interpolator spanning several, or ideally all PRBs does not avoid this completely as in that case the PRBs at the lower and upper edge of the CC frequency band can suffer from interpolation errors. Furthermore, known algorithms can have, depending on the channel characteristics, a relatively limited prediction horizon.

Embodiments of the invention aim to address one or several of the above issues. In accordance with an aspect there is provided a method for channel estimation comprising coordinating transmission of reference symbols for a multiple of carriers to cause coherent transmission of the reference symbols for facilitating a channel estimation procedure for the multiple of carriers on a bandwidth extending over the multiple of carriers.

In accordance with an aspect there is provided a method for channel estimation comprising receiving a coordinated transmission of reference symbols for a multiple of carriers on a bandwidth extending over the multiple of carriers, and performing a channel estimation procedure based on the reference symbols received on the bandwidth extending over the multiple of carriers.

In accordance with an aspect there is provided a coordinated set of reference symbols configured for a multiple of carriers for a coherent transmission of the reference symbols to facilitate a channel estimation procedure for the multiple of carriers on a bandwidth extending over the multiple of carriers.

In accordance with an aspect there is provided apparatus for a communication system, the apparatus comprising at least one processor, and at least one memory including computer program code, wherein the at least one memory and the computer program code are configured, with the at least one processor, to cause coordinated transmission of reference symbols for a multiple of carriers for facilitating a channel estimation procedure for the multiple of carriers on a bandwidth extending over the multiple of carriers.

In accordance with an aspect there is provided apparatus for channel estimation at a communication device, the apparatus comprising at least one processor, and at least one memory including computer program code, wherein the at least one memory and the computer program code are configured, with the at least one processor, to handle reception of a coordinated transmission of reference symbols for a multiple of carriers on a bandwidth extending over the multiple of carriers, and to perform a channel estimation procedure based on the reference symbols received on the bandwidth extending over the multiple of carriers.

The reference symbols may comprise for example channel state information reference symbols or demodulation reference symbols.

In accordance with a more detailed aspect the multiple of carriers comprise carrier aggregation component carriers.

The bandwidth may be extended from a bandwidth for a single carrier to extend on at least the bandwidth of the multiple of carriers.

Use of the extended bandwidth may be limited to a measurement phase of the reference signals. Periodic or configurable measurement phases may be provided.

Reference symbols for the multiple of carriers can be aligned over different carriers to form a set of wideband channel state information reference symbols or demodulation reference symbols.

At least one subsequent estimation for at least one individual carrier of a multiple of carriers may be provided based on a channel estimation procedure performed for the multiple of carriers.

A communication device may be provided with information relating to the coordinated transmission of reference symbols.

Coordination of reference symbols can comprises at least one of alignment of timing of the reference signals, alignment of phase of the reference signals, alignment of frequency offset of the reference signals, harmonisation of reference signal processes, time synchronization of reference signal transmission with respect to frame start time, synchronization of reference signal transmission with respect to subframe number in adjacent component carriers, use of same antenna ports on all component carriers, informing of receiving devices about the antenna ports used on all component carriers, and harmonising muting patterns of zero power channel state information reference signals in other cells. Use of the reference signals for the multiple of carriers may be coordinated between network elements operated by at least two different network operators. Channel state information reference signals may be staggered for different carriers. Reference signals for different carrier frequency bands may be arranged over different subframes. A receiver can be switched between the different carrier frequency bands accordingly.

Information based on measurement of said reference symbols may be communicated between a mobile device and a network entity.

A network element, for example an eNB or another controller of a base station or a communication device, for example a mobile station can be configured to operate in accordance with the various embodiments.

A computer program comprising program code means adapted to perform the herein described methods may also be provided. In accordance with further embodiments apparatus and/or computer program product that can be embodied on a computer readable medium for providing at least one of the above methods is provided.

It should be appreciated that any feature of any aspect may be combined with any other feature of any other aspect.

Embodiments will now be described in further detail, by way of example only, with reference to the following examples and accompanying drawings, in which:

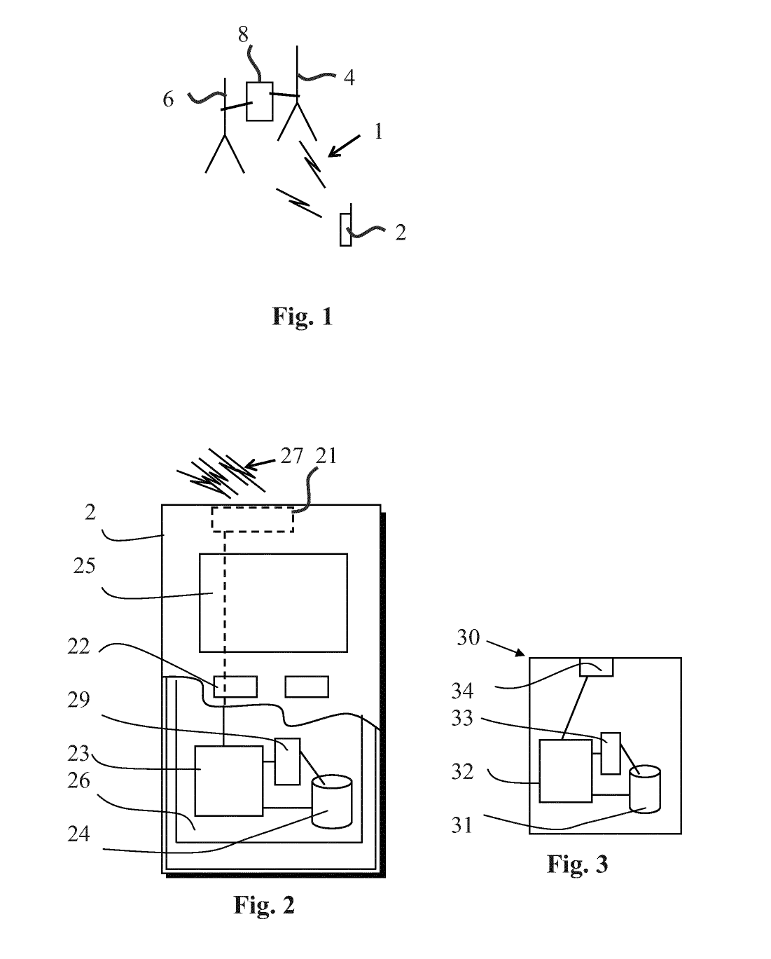

FIG. 1 shows a schematic diagram of cell aggregation according to some embodiments;

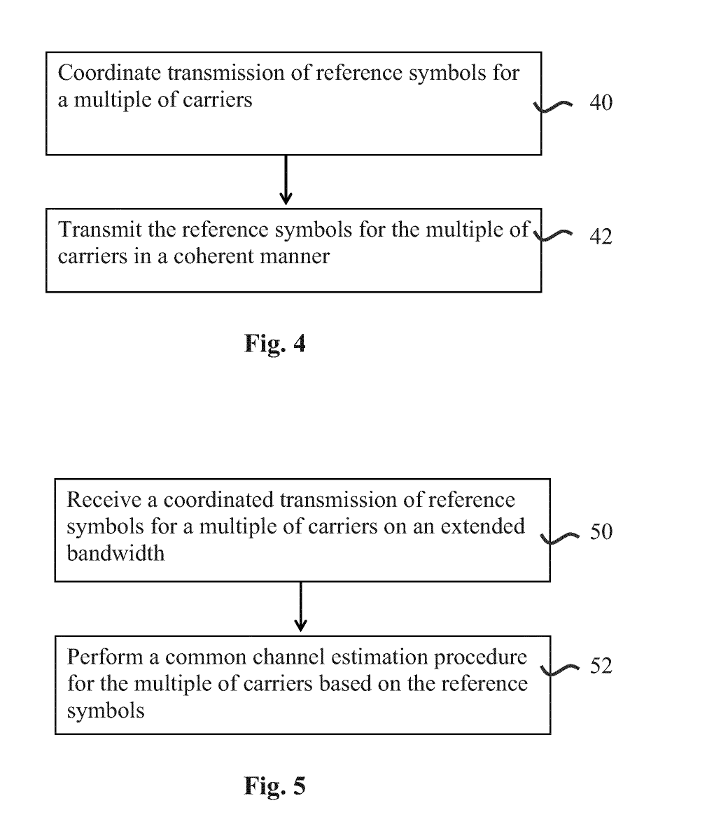

FIG. 2 shows a schematic diagram of a mobile communication device according to some embodiments;

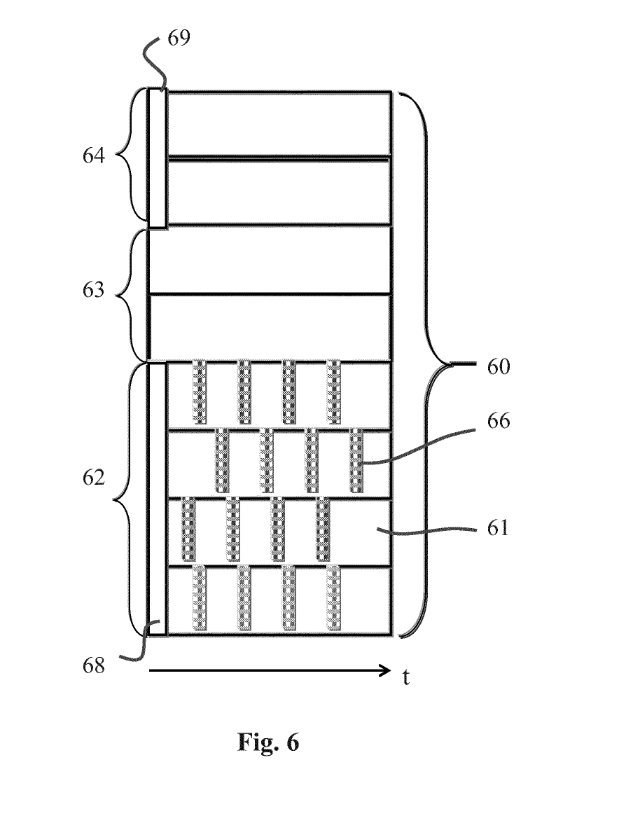

FIG. 3 shows a control apparatus according to some embodiments;

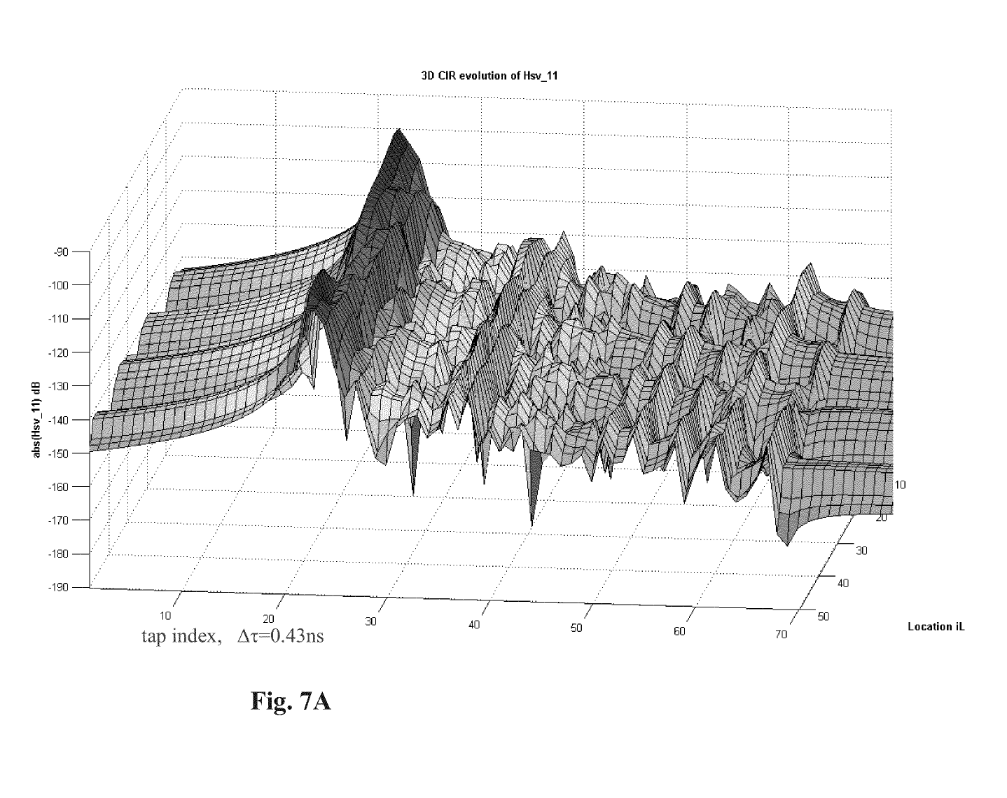

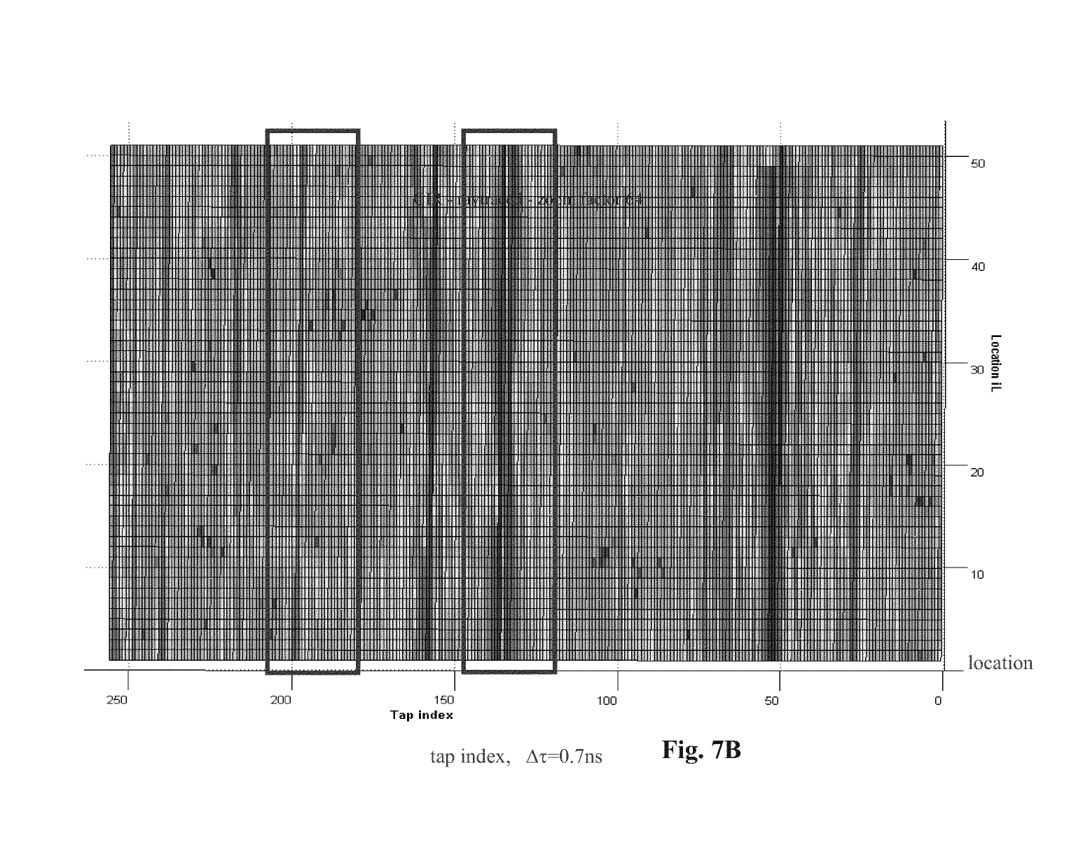

FIGS. 4 and 5 show schematic flowcharts according to certain embodiments;

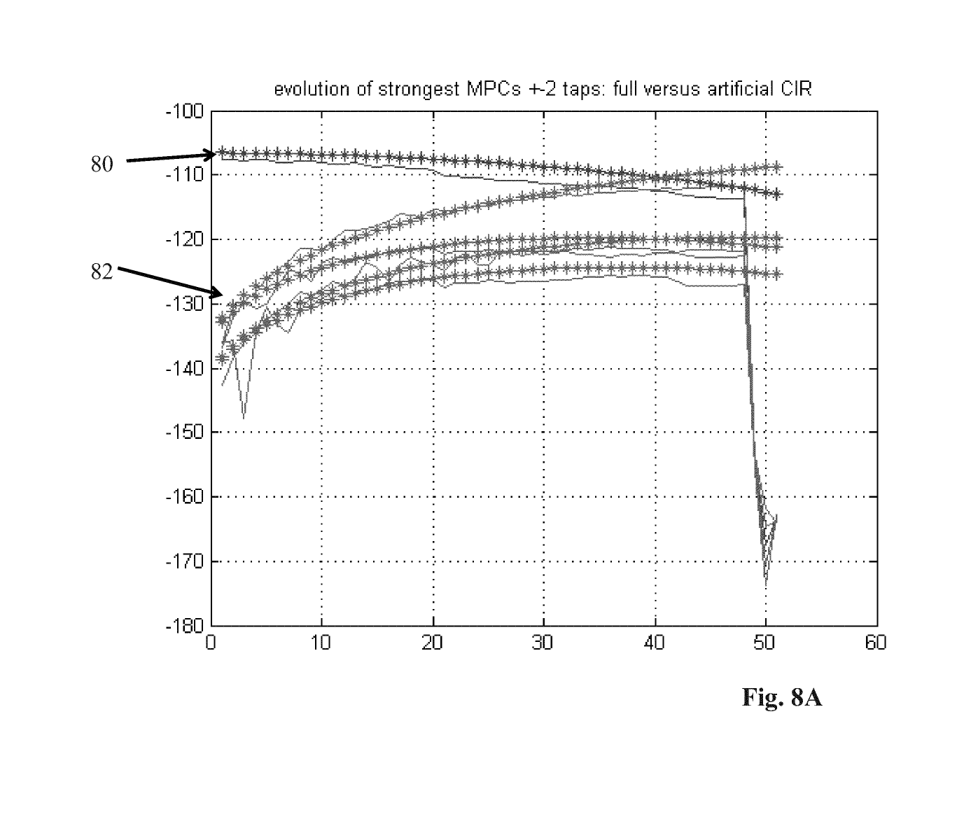

FIG. 6 shows a frame illustrating extended channel state information reference symbol measurement bandwidth, and

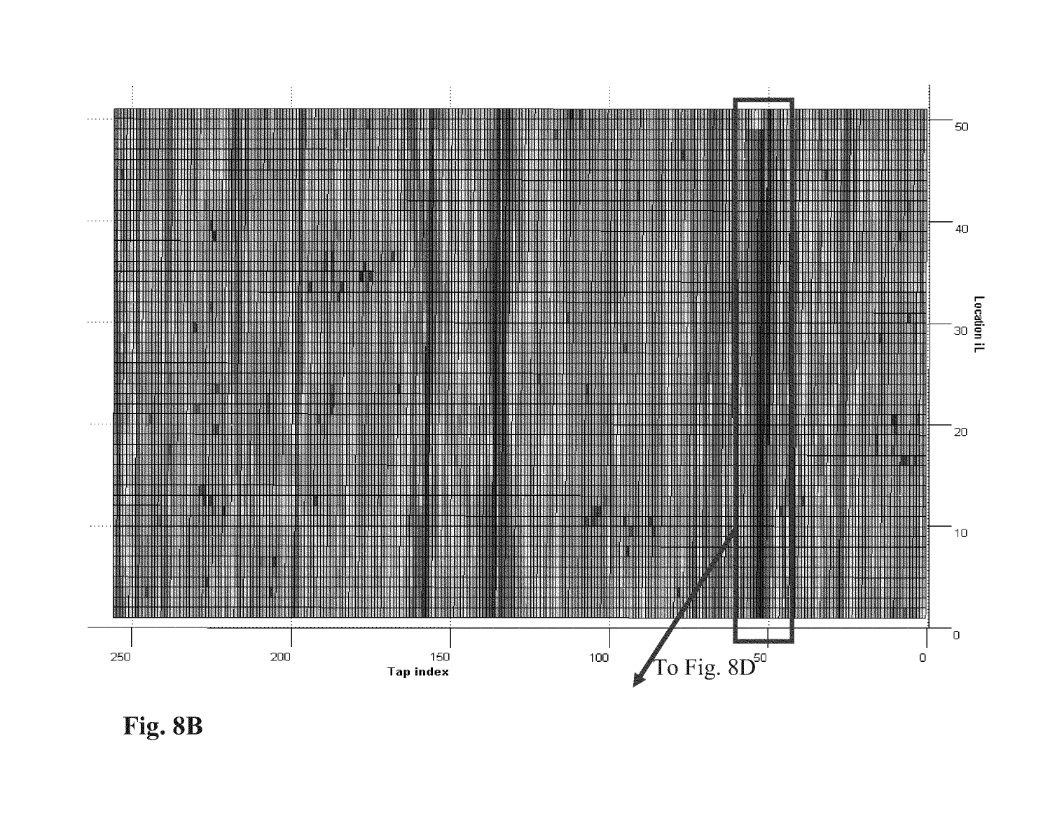

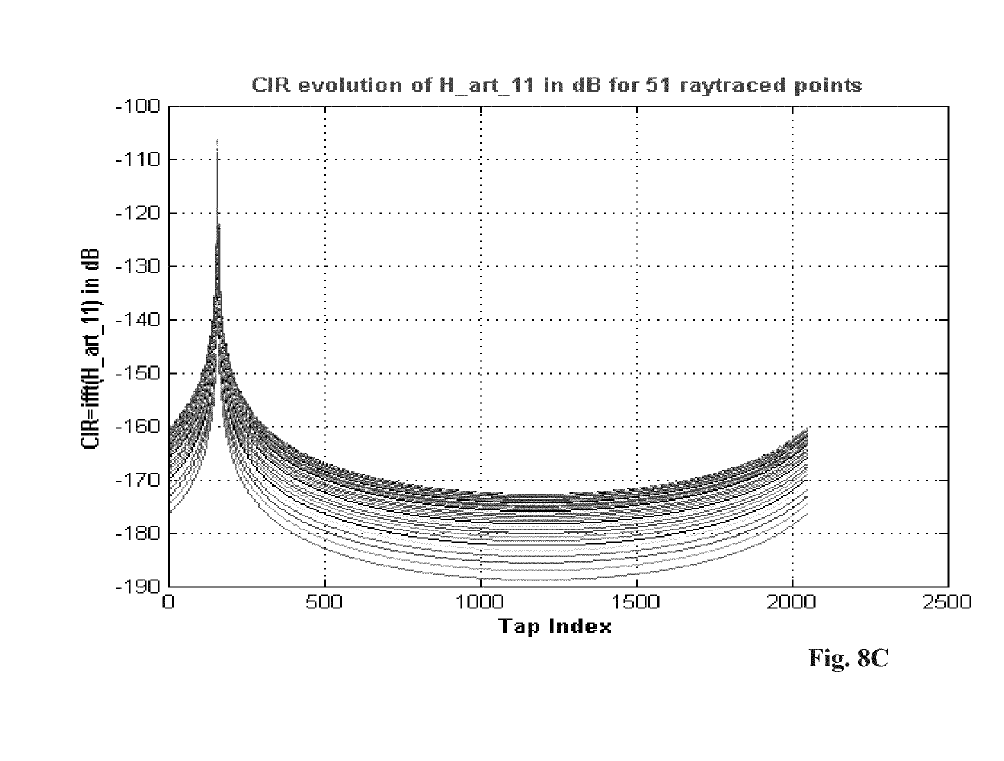

FIGS. 7 and 8 show simulation results in accordance with certain embodiments.

In the following certain exemplifying embodiments are explained with reference to a wireless or mobile communication system capable for communications with mobile communication devices over a multiple of carriers. Before explaining in detail the exemplifying embodiments, certain general principles of a wireless communication system, access systems thereof, mobile communication devices and cell aggregation are briefly explained with reference to FIGS. 1 to 3 to assist in understanding the technology underlying the herein described examples.

A communication device 2 is typically provided wireless access via antenna arrangement of at least one base station or similar wireless transmitter and/or receiver node of an access system. In FIG. 1 two radio base stations 4 and 6 are shown, each providing a radio service area known as a cell. It is noted that instead of two cells, any number of cells can be provided in a communication system. Also, a base station site can provide more than one cell or sector. Each communication device and base station may communicate over one or more radio links and may send signals to and/or receive signals from more than one source. The details depend on the application.

A non-limiting example of the recent developments in communication system architectures is the long-term evolution (LTE) of the Universal Mobile Telecommunications System (UMTS) that is being standardized by the 3^{rd} Generation Partnership Project (3GPP). Further development of the LTE is referred to as LTE-Advanced. Yet further developments such as ‘beyond 4G’ have also been considered. The LTE employs a mobile architecture known as the Evolved Universal Terrestrial Radio Access Network (E-UTRAN). Base stations or base station systems of such architectures are known as evolved or enhanced Node Bs (eNBs). An eNB may provide E-UTRAN features for cells such as user plane Radio Link Control/Medium Access Control/Physical layer protocols (RLC/MAC/PHY) and control plane Radio Resource Control (RRC) protocol terminations towards the communication devices. Other examples of radio access include those provided by base stations of systems that are based on technologies such as wireless local area network (WLAN) and/or WiMax (Worldwide Interoperability for Microwave Access).

In case of LTE Release 10 or higher device 2 and base station 4 and 6 might receive/provide multiple component carriers. The component carriers may be provided over a Multiple Input/Multiple Output (MIMO) antenna system. MIMO arrangements as such are known. MIMO systems use multiple antennas at the transmitter and receiver along with advanced digital signal processing to improve link quality and capacity. For spatial multiplexing the throughput increases with the number of antenna elements.

Base stations are typically controlled by at least one appropriate controller apparatus so as to enable operation thereof and management of mobile communication devices in communication with the base stations. The control apparatus can be interconnected with other control entities. The control apparatus can typically be provided with memory capacity and at least one data processor. The control apparatus and functions may be distributed between a plurality of control units. In some embodiments, each base station can comprise a control apparatus. In alternative embodiments, two or more base stations may share a control apparatus. In some embodiments at least a part of control apparatus may be respectively provided in each base station. FIG. 1 shows a network element 8 providing control on transmitting element 4 and 6. The element can provide a coordinating function described in more detail later for example based on appropriate self-organising network (SON) processes, by means of an eNB or a central control unit of a CoMP cooperation area.

A possible mobile communication device for communication over a plurality of carriers will now be described in more detail with reference to FIG. 2 showing a schematic, partially sectioned view of a communication device 2. Such a communication device is often referred to as user equipment (UE) or terminal. An appropriate mobile communication device may be provided by any device capable of sending radio signals to and/or receiving radio signals on multiple of carriers. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information.

The mobile device may receive signals via a multiple of carriers over an air interface 27 via appropriate apparatus for receiving and may transmit signals via appropriate apparatus for transmitting radio signals. In FIG. 2 transceiver apparatus is designated schematically by block 21. The transceiver apparatus 21 may be provided for example by means of a radio part and associated antenna arrangement. The antenna arrangement may be arranged internally or externally to the mobile device.

A mobile communication device is also provided with at least one data processing entity 23, at least one memory 24 and other possible components 29 for use in software and hardware aided execution of tasks it is designed to perform, including control of access to and communications with base station systems and other communication devices. The data processing, storage and other relevant control apparatus can be provided on an appropriate circuit board and/or in chipsets. This feature is denoted by reference 26.

The user may control the operation of the mobile device by means of a suitable user interface such as key pad 22, voice commands, touch sensitive screen or pad, combinations thereof or the like. A display 25, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus for a communication system, for example to be coupled to and/or for controlling one or more stations providing cells. It is noted that in some embodiments each base station comprises a separate control apparatus that may communicate control data with each other. The control apparatus 30 can be arranged to provide control on communications in the service area of the system. The control apparatus 30 can be configured to provide control functions in association with communication on multiple carriers by means of data processing facility in accordance with certain embodiments described below. For this purpose the control apparatus comprises at least one memory 31, at least one data processing unit 32, 33 and an input/output interface 34. Via the interface the control apparatus can be coupled to a receiver and a transmitter of the base station. The control apparatus can be configured to execute an appropriate software code to provide the control functions. It shall be appreciated that similar component can be provided in a control apparatus provided elsewhere in the system for controlling reception of sufficient information for decoding of received information blocks.

The following describes certain exemplifying embodiments where multiple carriers are used in combination with arrangements such the above discussed coordinated multipoint transmission (CoMP). CoMP can be provided for example in network scenarios where there is a centralised processing unit. An example of such units is a single controlling eNB. For example, in LTE Release 10 or higher carrier aggregation allows combining of up to five contiguous component carriers (CC) or CCs from different frequency bands to increase the overall bandwidth. It is noted that although the detailed examples below relate to channel estimation to provide channel state information (CSI), similar principles apply to channel estimation for other purposes, for example for demodulation.

Providing an extended bandwidth for channel estimation is not without challenges. An issue is that a receiving device measures on one single component carrier at a time. Also, different reference signal processes on different component carriers might for example apply different repetition rates and/or different allocation of non-zero power reference signals and muting patterns. Each CC can have its own cell ID and as reference symbols are defined by sequences defined by the cell ID, the receiving device would need to know all cell IDs for all CCs to do a measurement on the extended bandwidth.

Flowchart of FIG. 4 shows a method for channel estimation aiming to address these issues. At step 40 transmission of reference symbols on a multiple of carriers is coordinated to cause coherent transmission of the reference symbols for facilitating a common channel estimation procedure over a multiple of carriers. For example, estimation may be provided up to five component carriers. The reference symbols are transmitted at 42 from one or more transmitting stations in said coordinated manner to at least one receiving device.

FIG. 5 shows operation at a device receiving the reference symbols. A coordinated transmission on the extended bandwidth of the reference symbols is received at 50 for the multiple of carriers. A common channel estimation procedure is then performed at 52 for the reference symbols received on the bandwidth extending over the bandwidth of the multiple of carriers.

A coordinated set of reference symbols can be configured for a multiple of carriers for enabling the coherent transmission of the reference symbols. The coordination facilitates a common channel estimation procedure for the multiple of carriers on bandwidth extending over the multiple of carriers.

To provide coordinated transmission of the reference symbols on a multiple of carriers each providing a frequency resource, the bandwidth for the estimation is extended from covering one frequency resource to cover at least the entire frequency resources used by the multiple of carriers. For example, in case of carrier aggregation component carriers the measurement bandwidth is increased from the bandwidth of a single component carrier to the bandwidth of a multiple of component carries. For example, the bandwidth can be increased from a 20 MHz bandwidth of a single LTE Release 8 frequency band to a 100 MHz bandwidth. Generally the bandwidth should be increased as far as possible. An eNB or another controlling entity can ensure the possibility to use e.g. wideband reference signals by aligning features such as phase, frequency offset and timing as well as reference signal processes between the available component carriers so that UEs are able to do meaningful wideband measurements.

The aligned or newly introduced set of reference signals, termed herein wideband channel state information reference signals (WB-CSI RS) may be provided for example by aligning reference signals over several contiguous or non-contiguous radio frequency (RF) carriers. The WB-CSI RS as such can be almost similar or even the same as those used for single frequency band CSI RSs but the WB-CSI RSs are harmonized over several carriers. This can be provided by alignment of the transmission time and the transmission phase. The harmonization may also include further aspects like the measurement sets, muting patterns of other CSI RS and any other aspects relevant e.g. for systems based on CoMP, MIMO and beamforming to guarantee good channel estimation quality.

Coordinated alignment of CSI RSs transmission can be provided on per mobile network operator basis, or between several mobile network operators active in a certain area and using the same radio sites. The alignment can be provided so that all UEs in the area have the chance to measure the radio channels on the wideband CSI RSs.

Specific UE messages can be defined for informing UEs about opportunity for accurate channel estimation. New messages can be used for informing the UEs about the potential for wideband measurements, about the carriers (CC) which will transmit aligned WB-CSI RSs, about the frames and/or subframes which will transmit harmonized WB-CSI RSs over the respective CCs and so on. Furthermore the UEs can report the measurement bandwidth they used for their CSI estimation. A reliability parameter for the CSI reports may also be derived and reported.

More accurate reporting by the UEs can be provided based on the WB CSI RS based measurements. The reporting can provide the results of wideband measurements or a wideband reporting of the CSI over all measured CCs. In the latter case an appropriate network entity, for example an eNB can perform an improved parameter estimation or reduction of band edge effects.

Instead of sending dedicated control information to a UE it is also possible to provide the estimation without informing the UE. In such occasion the UE may perform a blind detection of the wideband CSI RSs. In case different component carriers transmit conventional CSI RSs and these are aligned, the blind detection can include the blind detection of the cell ID on each component carrier and access point (AP) port being used and so on.

The alignment may include time synchronization of CSI RS transmission with respect to frame start time as well as subframe number in adjacent component carriers (CC). Same antenna ports may be used on all CCs and/or all UEs may be informed about used antenna ports on all used CCs. Furthermore the muting patterns of zero power CSI reference signals in other cells can be harmonized to achieve similar signal to interference noise ratio (SINR) on all CCs.

In accordance with an example it is assumed that a mobile network operator (MNO) can provide sufficient frequency bands to offer carrier aggregation. The CSI RS can be aligned over the different carrier frequencies and to form a wideband WB-CSI RS spanning over all available carriers. This is illustrated by in FIG. 6 depicting a frequency division duplex (FDD) system with four 20 MHz component carriers 61 in downlink (DL) direction 62 and two component carriers in uplink (UL) direction 64. A guard band 63 is provided between DL and UL the FDD. In the DL conventional CSI RSs 66 are transmitted in an uncoordinated manner, this being indicated by the missing time alignment between the CCs in time t. For the optimized scheme a wideband DL CSI RS 68 has been added at the beginning of the DL frame. The wideband DL CSI RS 68 is aligned over all CCs, being depicted by the single rectangle going over all DL CCs having exactly the same timing.

Component carrier 61 may comprise e.g. physical downlink shared channel and/or a physical downlink control channel.

In this example the DL WB-CSI RSs extend over four component carriers but this is not the only possibility. For example, with LTE Release 10 carrier aggregation a zoom factor up to five resulting in an extension to 100 MHz is possible.

In accordance with a possibility both UL and DL are included in the wideband channel estimation for a UE as indicated by reference 60. Both the downlink part 68 and uplink part 69 of the DL- and UL reference signals are aligned in time. This allows for a zoom factor in the order of ten, assuming five component carriers in each direction.

All UEs from all component carriers may use the wideband measurement phases and then fall back for data transmission to their according component carrier afterwards. UEs may be connected to only one single component carrier for data transmission (e.g. on PDSCH). The bandwidth extension can be limited to cover the CSI measurement phase only while the data transmission might be limited to one of the component carriers.

Especially in case of more than one operator the wideband measurement phases might restrict scheduler operation. Additional WB-CSI RSs may also cause overhead in certain applications. A wideband aligned WB-CSI RS can be used for providing a first estimate whilst use of wideband estimation can otherwise be limited to periodic or configurable/semi-static measurement phases. In such cases wideband based channel estimation can be used in combination with tracking approaches. For example, WB-CSI measurement phases can be used to get a first or initial good estimate of unobservable multipath components (MPCs). Based on a resulting good estimate of the MPC parameters these can be tracked over quite some time with good accuracy to detect further evolution of parameters for the relevant MPCs.

Multiple mobile network operators (MNO) may be involved in providing the component carriers. This may be provided e.g. by means of radio access network (RAN) sharing, or site sharing, between several MNOs. In such case coordination of the wideband measurement phases can be agreed between the MNOs by exchanging appropriate messages configured for asking and agreeing on use of common WB-CSI RSs. Detail than may need to be agreed on comprise timing, subframe number(s), access point(s), repetition rate, and so on. For example, the coordination may be provided based in a multi RAN SON area. The coordination between the MNOs may be provided in distributed or centralized manner. Similar exchange of messages can be provided and similar approaches applied to cognitive radio arrangements.

In certain applications where multiple operators are involved WB-CSI RSs can be transmitted from the same antennas over all component carriers. In site sharing each operator may use its own equipment including the antennas provided in a single site. Antennas of different operators can be separated, e.g. by an appropriate distance (typically a few meters or so). In these instances a mechanism for antenna sharing may be needed between operators when more than one operator is involved in providing the multiple of carriers. For full wideband CSI RSs the reference symbols may need to be transmitted from a single antenna as otherwise the radio channels would be different. In an approach for resolving this MNOs may transmit, even if they are on the same site, their signals from different antennas. In such situation specific wideband measurement phases can be agreed on between the MNOs. In these phases one of the MNOs mutes in accordance with a mutual agreement its CSI RSs on its carrier when the other MNO is transmitting its WB-CSI RSs from its own antennas. This can be agreed on a per frame basis to adapt to varying load conditions of the MNOs. The X2 and/or S1 interface may be used for message exchange and alignment between controllers of the antennas.

Specific WB CSI-RSs and organization may be defined over X2 and/or by self-organising network (SON) algorithms to generate consistent WB CSI RSs. This may be particularly advantageous if tight RAN sharing including antenna elements is not an option for a multi-operator scenario.

One or more of the carriers may be unavailable, for example being used by the owner of the component carrier (CC) for one or several frames. The other MNO can mute its transmission of the WB-CSI RS on these carriers. This generates only moderate performance losses as long as the overall bandwidth is kept more or less constant as the estimation improvements can be achieved with un-contiguous spectrum as well.

In accordance with another possibility carriers are allocated to MNOs in a staggered fashion to avoid the need of mutual muting while still have the bandwidth expansion gain. The last proposal would have a clear connection to cognitive radio or spectrum sharing. All CCs can be assigned to an operator at a time and the next time instant all CCs would then go to a next operator. That way both operators can have the same available spectrum as before but can also transmit their individual WB CSI RSs without further coordination. Only one CC may need to be continuously available per MNO for backwards compatibility to serve e.g. LTE Release 8 UEs.

Non-contiguous carrier aggregation from different frequency bands, for example 2.1+2.6 GHz, can be used to allow for a further increase of the measurement bandwidth to about 0.5 GHz. This may require UEs to be provided with appropriate wideband Rx receivers and variable Rx filters. Assuming suitable calibration and/or synchronization means one can consider further to transmit WB-CSI RSs in different bands sequentially over different subframes to allow UEs to switch between different carrier frequency bands. This may be provided at least during the measurement phase.

In case of frequency division duplex (FDD) the uplink frequency band, this being about 100 MHz apart from the DL frequency band, can be integrated into the CSI estimation.

Calibration and harmonization of DL and UL transmission of WB-CSI RSs and sounding reference signals can be provided accordingly. Specific WB-SRS allow for frequency selective CSI estimation over the full UL frequency band.

Extra overhead during the transmission of wideband CSI RSs may be avoided if transmission of conventional, e.g. LTE Release 10 CSI RSs, takes place at the same time. The CSI RSs used for narrowband and the WB-CSI RSs can be harmonised as far as possible to improve the overall channel estimation.

For the wideband CSI measurements the measuring device, e.g. a UE, may need to adapt its input filters. Wideband low noise Rx amplifiers can also be provided. Fixed filter bandwidth, e.g. 20 MHz, can be utilised by making CSI estimations per 20 MHz carrier sequentially and combining the results afterwards artificially. The WB-CSI RS transmission from the eNBs can be staggered accordingly and harmonized with the UE reception phases.

User equipment can be served by their primary component carrier and may be scheduled on secondary component from time to time. However, this may not happen at all. If one operator has several adjacent CCs the UEs can benefit nonetheless from wideband CSI RS measurements. Without WB CSI RSs UEs might try to align measurements from different CCs in case they are scheduled into these CCs. However, if WB CSI RSs is provided the UEs can measure all of these without being scheduled on more than one CC.

Appropriate signalling may be provided for ensuring that base station controllers or eNBs are made aware of whether UEs are reporting CSI on narrow or wideband CSI measurements. Similarly, UEs may be informed whether a eNB transmits wideband reference signals, and if so what type of wideband reference signals.

Appropriate apparatus or means can be provided for controlling a communication device and a network element to provide the various embodiments. The apparatus or means can be configured to process bandwidth increases from a bandwidth for a single carrier to extend on at least the bandwidth of the multiple of carriers. The apparatus or means can be configured to align channel state information reference symbols for the multiple of carriers over different carriers and/or frequencies to form a set of wideband channel state information reference symbols. The apparatus or means may be configured to limit the use of the extended bandwidth to a measurement phase of the channel state information reference signals, for example periodically or in a configurable manner. The apparatus or means can be configured to use channel state information reference symbols with aligned timing, aligned phase, and/or aligned frequency offset. Harmonisation of channel state information reference signals processes, time synchronization of channel state information reference signal transmission with respect to frame start time, synchronization of channel state information reference signal transmission with respect to subframe number in adjacent component carriers, use of same antenna ports on all component carriers, and/or harmonising of muting patterns of zero power channel state information reference signals in other cells is also possible. Coordination may also comprise integrating channel state information estimation of uplink and downlink carrier frequency bands. The apparatus or means can be also arranged to stagger channel state information reference signals for different carriers and/or to arrange channel state information reference signals for different carrier frequency bands over different subframes. A receiver of the reference symbols can be switched between the different carrier frequency bands accordingly. The apparatus or means can also be arranged Information based on measurement of said channel state information reference symbols may be communicated between a mobile device and a network entity.

The effect of widening the measurement bandwidth have been analysed by simulations. Before explaining the results, some of the issues relating to the measurements and estimation are discussed in further detail. For example, for joint precoding in the downlink (DL) the accuracy of the channel estimation as such depends, inter alia, on the used overhead for channel state information (CSI) reference signals (RS). A so called model based channel estimation concept has been suggested, which would allow under the assumption of a perfect building vector data model (BVDM) a long reaching channel prediction with extremely low feedback overhead. It replaces per physical resource block (PRB) reporting of the channel transfer function (CTF) by a feedback of the three-dimensional user equipment (UE) location with respect to a known model of the eNB surrounding. This enables the eNB to reconstruct the wideband radio channel for one or even several channel components, thereby achieving a significant feedback reduction. Model errors of the BVDM may however require an additional estimation of model parameters like the amplitude, phase or delay of multi path components based on conventional channel state information (CSI) measurements, for example those relying on the LTE Release 9/10 CSI RS reference signals. It would be desirable to increase the accuracy as well as the prediction horizon of channel estimation and prediction.

For a typical measurement bandwidth of e.g. 20 MHz each tap of the channel impulse response (CIR) contains ten to more multipath components (MPC) making an accurate estimation of the hidden parameters (phase, amplitude, delay, etc.) of these MPCs difficult, or even impossible. This challenge also applies for the common space alternating generalized expectation maximization (SAGE) algorithm, which attempts to estimate iteratively the parameters for a limited number of MPCs. The number of MPCs has to be limited to a few as otherwise the system might get overly complex. The inventor has found that for achieving a normalized mean square error (NMSE) of less than +20 dB for the estimation, or similarly the prediction, about 200 or more MPCs will have to be estimated accurately, this being far beyond the ten MPCs of the typical feasibility range for the SAGE algorithm. Model based channel prediction has similarities to the SAGE algorithm in the sense that it also tries to provide the parameters of all MPCs. Due to inaccuracies of the BVDM model based channel prediction (MBCP) is tightly combined with SAGE like channel estimation and prediction techniques and will therefore suffer similarly from the short comings of the SAGE algorithm.

Estimation of hidden multipath components (MPCs) can be divided into tractable sub-problems to minimise the number of MPCs per sub-problem. The estimation itself may be based on an estimation mechanism such as the SAGE or the like. A possible way to achieve this is to increase the measurement bandwidth. Bandwidth may be maximised for CSI estimation e.g. by performing the estimation over several components carriers (CCs). Increase in the measurement bandwidth increases the number of taps forming the channel impulse response (CIR) and accordingly reduces the number of hidden unobservable MPCs per tap. The measurement bandwidth can be increased to convert a basically intractable estimation of multipath components into relatively easy to solve sub-problems.

FIG. 7B illustrates the effect for a large extension factor, called below zoom factor, of 64. The zoom factor can be defined as the relative increase of the measurement bandwidth with respect to the original bandwidth, which is in our example 20 MHz as defined for LTE Release 8. It is noted that the evaluation is done here based on a ray tracing tool allowing for easy implementation of even extremely large zoom factors like 64. Such zooming factors result in an overall bandwidth of 64*20 MHz, i.e. a bandwidth of more than 1 GHz. The effect of such large zoom factors can be seen from FIGS. 7A and B depicting the CIR for the original (FIG. 7A) and the increased bandwidth (FIG. 7B). For the large bandwidth there is just an overlap of one to maybe two MPCs for few adjacent taps allowing to do the estimation parameters like delay τ, amplitude, etc. for each MPC with small to very small inter tap crosstalk and therefore with high accuracy. This is illustrated in more detail in FIGS. 8 A-D for one of the MPCs, indicating a large possible prediction horizon. In simulations a prediction over about one λ for a signal to noise ratio (SNR) of 20 dB with good accuracy has been found to be possible, which is about a factor of ten larger than what is possible for the state of the art Kalman filtering.

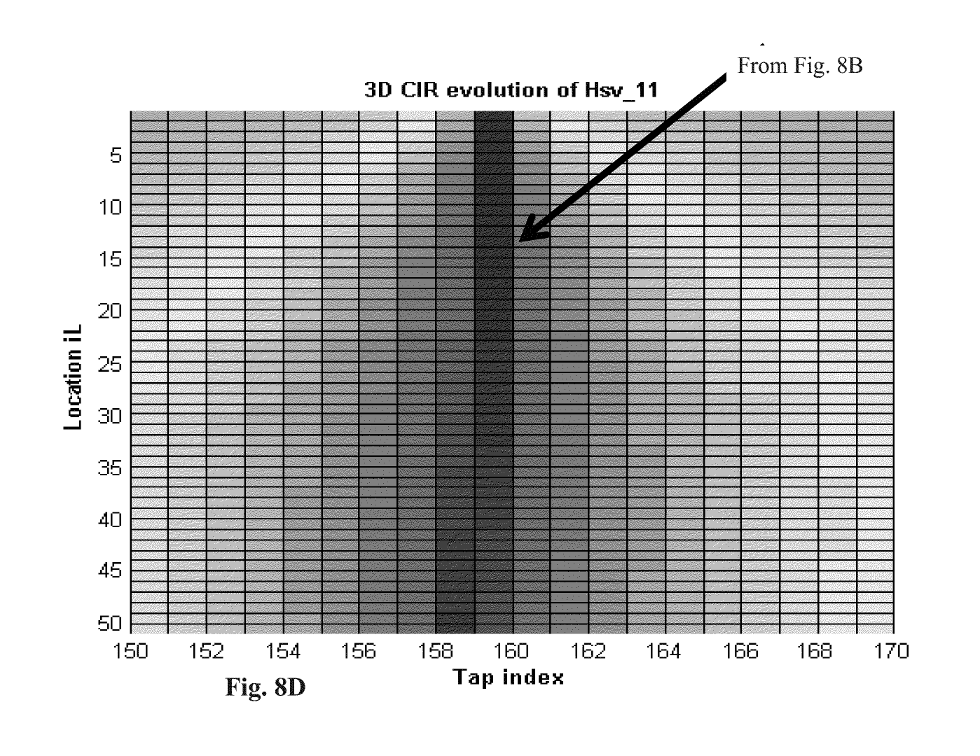

More particularly, FIGS. 8A-D shows exemplary estimation of the parameters of the strongest MPC for illustration with high accuracy due to the limited interaction between different MPCs. FIG. 8A shows evolution of strongest tap 80 and its neighbours 82 for full and reconstructed CIR based on estimated MPC parameters. The full CIR is depicted by solid lines and the reconstructed CIR by the lines of *. The still visible differences between full and reconstructed evolution of the strongest MPC in FIG. 8A are due to remaining inter tap interference, which can be compensated for as soon as all MPCs have been estimated. FIG. 8B shows part of the CIR with x-axis as tap number and y-axis the locations from 0 to 50 cm. FIGS. 53C and D show CIR of a reconstructed MPC.

Thus, instead of sending reference symbols for channel sounding separately on different carriers in an uncoordinated manner (e.g. at different times or in a non-coherent manner) these can be sent in a coordinated fashion on a multiple of carriers to provide coherent or harmonised high resolution channel estimation over the multiple carriers. By doing so, the performance of high-resolution channel estimators can be improved. This may be provided even when the carriers are non-adjacent in frequency. Also, band-edge problems may be mitigated for simple channel estimators. A specific benefit of the proposed wideband reference signals is a possibility of a much more accurate and decoupled estimation of the multipath components of typical macro cellular radio channel impulse responses. Beside a good accuracy complexity of the channel estimation and prediction may be decreased as the parameter estimation can be parallelised, i.e. is increasing just with O(N) of number of relevant multi path components. Higher resolution can be obtained for channel impulse response due to enlargement of the bandwidth. This allows for a greater accuracy for the channel estimation and prediction. The improved channel prediction may provide for example more robust precoding.

The required data processing apparatus and functions of a base station apparatus, a communication device and any other appropriate element may be provided by means of one or more data processors or other means arranged to provide the required functions. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

An appropriately adapted computer program code product or products may be used for implementing the embodiments, when loaded or otherwise provided on an appropriate data processing apparatus, for example for causing determinations when, what and where to communicate and communications of information between the various nodes. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is noted that the issues are not limited to any particular communication system, standard, protocol, specification, radios, or link direction and so forth, but may occur in any communication device and/or system where channel estimation for multiple carriers may be needed. The various examples above can be provided as alternatives or as complementary solutions. Whilst embodiments have been described in relation to communication system such as those based on the LTE systems and 3GPP based systems and certain current and possible future version thereof, similar principles can be applied to other communication systems. For example, this may be the case in applications where no fixed station equipment is provided but a communication system is provided by means of a plurality of user equipment, for example in ad hoc networks. Also, the above principles can also be used in networks where relay nodes are employed for relaying transmissions between stations. Therefore, although certain embodiments were described above by way of example with reference to certain exemplifying architectures for wireless networks, technologies and standards, embodiments may be applied to any other suitable forms of communication systems than those illustrated and described herein. It is also noted that different combinations of different embodiments are possible. It is also noted herein that while the above describes exemplifying embodiments of the invention, there are several variations and modifications which may be made to the disclosed solution without departing from the spirit and scope of the present invention.

1.-21. (canceled)

22. A method for channel estimation comprising:
coordinating transmission of reference symbols for multiple carriers to cause coherent transmission of the reference symbols for facilitating a channel estimation procedure for the multiple carriers on a bandwidth extending over the multiple carriers.

23. A method for channel estimation comprising:
receiving a coordinated transmission of reference symbols for multiple carriers on a bandwidth extending over the multiple carriers, and
performing a channel estimation procedure based on the reference symbols received on the bandwidth extending over the multiple carriers.

24. A method according to claim 23, wherein the multiple carriers comprise carrier aggregation component carriers.

25. A method according to claim 23, comprising extending the bandwidth from a bandwidth for a single carrier to extend on at least the bandwidth of the multiple carriers.

26. A method according to claim 23, wherein use of the extended bandwidth is limited to a measurement phase of the reference signals.

27. A method according to claim 26, comprising use of periodic or configurable measurement phases.

28. A method according to claim 23, wherein the reference symbols are aligned over different carriers to form a set of wideband channel state information reference symbols or wideband demodulation reference symbols.

29. A method acccording to claim 23, comprising, subsequent to the performing the channel estimation procedure for the multiple carriers, performing at least one estimation for at least one individual carrier of the multiple carriers based on the channel estimation procedure for the multiple carriers.

30. A method according to claim 23, comprising providing a communication device with information relating to the coordinated transmission of the reference symbols.

31. A method according to claim 22, wherein the performing coordinating comprises performing at least one of alignment of timing of the reference signals, alignment of phase of the reference signals, alignment of frequency offset of the reference signals, harmonisation of reference signal processes, time synchronization of reference signal transmission with respect to frame start time, synchronization of reference signal transmission with respect to subframe number in adjacent component carriers, use of same antenna ports on all component carriers, informing of receiving devices about the antenna ports used on all component carriers, and harmonising muting patterns of zero power reference signals in other cells.

32. A method according to claim 23, comprising coordinating use of the reference signals for the multiple carriers between network elements operated by at least two different network operators.

33. A method according to claim 23, comprising staggering the reference signals for different carriers.

34. A method according to claim 23, wherein the reference signals for different carrier frequency bands are arranged over different subframes, the method comprising switching the receiver between the different carrier frequency bands accordingly.

35. A method according to claim 23, comprising communicating information between a mobile device and a network entity based on measurement of the reference symbols.

36. Apparatus for a communication system, the apparatus comprising at least one processor, and at least one memory including computer program code, wherein the at least one memory and the computer program code are configured, with the at least one processor, to cause a coordinated transmission of reference symbols for multiple carriers for facilitating a channel estimation procedure for the multiple of carriers on a bandwidth extending over the multiple carriers.

37. Apparatus for channel estimation at a communication device, the apparatus comprising at least one processor, and at least one memory including computer program code, wherein the at least one memory and the computer program code are configured, with the at least one processor, to:
receive a coordinated transmission of reference symbols for multiple carriers on a bandwidth extending over the multiple carriers, and
perform a channel estimation procedure based on the reference symbols received on the bandwidth extending over the multiple carriers.

38. A computer program comprising code adapted to perform the steps of claim 23 when the program is run on processor apparatus.
